(19) United States
(12) Patent Application Publication
(10) Pub. No.: US 2014/0359147 A1
(43) Pub. Date: Dec. 4, 2014

(54) SYSTEMS AND METHODS OF COMMUNICATING VIA A WEB BROWSER

(71) Applicant: Bandwidth.com, Inc., Raleigh, NC (US)

(72) Inventors: Brad Roldan, Sunnyvale, CA (US); Doug Neumann, Cary, NC (US); Steve McKinnon, Cary, NC (US); Tyler Cross, Raleigh, NC (US)

(21) Appl. No.: 14/461,497

(22) Filed: Aug. 18, 2014

Related U.S. Application Data
(60) Provisional application No. 61/971,557, filed on Mar. 28, 2014.

(51) Int. Cl. H04L 29/06; H04L 29/12; H04L 29/08

(52) U.S. Cl. CPC H04L 65/1069; H04L 67/16; H04L 65/1006; H04L 61/106
USPC 709/228

(57) ABSTRACT

Various embodiments are directed to techniques for placing and receiving calls via a web-browser interface. In some embodiments communication connection logic may be be executed by a processor component to receive a request to establish a bi-directional communication session between a first endpoint and multiple endpoints via a uniform resource indicator (URI) accessed via a web browser of the first endpoint, identify the second endpoints based on the URI, send a connection request to at least one of the second endpoints, receive a connection acceptance response from at least one of the second endpoints, and establish the bi-directional communication session between the first endpoint and the second endpoints. Other examples are described and claimed.

### CROSS-REFERENCE TO RELATED APPLICATIONS

This application claims the benefit of and priority to previously filed U.S. Provisional Patent Application Ser. No. 61/971,557 entitled “Systems and Methods of Communicating Via Web Browser” filed on Mar. 28, 2014, the subject matter of which is hereby incorporated by reference in its entirety.

### TECHNICAL FIELD

Examples described herein are generally related to techniques for placing and receiving calls via a web-browser interface.

### BACKGROUND

People often have multiple phone numbers and multiple devices associated with the phone numbers. For example, a person may have a home telephone number associated with a home phone, a mobile telephone number associated with a mobile device, an office telephone number associated with an office phone, and the like. The user is rarely in a location in which incoming calls to any of the numbers will always notify the person of an incoming call. Moreover, others that try to contact the person may have to remember multiple numbers if the first number did not result in a connection. Creating a non-numeric web-based universal resource indicator (URI) that may be used to access a person greatly simplifies the process of establishing a communication session with that person. Others need only remember the URI of the person and have access to a web-browser or other soft-client capable of addressing a URI to contact them. It is with respect to these and other considerations that the embodiments described herein are needed.

### BRIEF DESCRIPTION OF THE DRAWINGS

FIG. 1 illustrates an example system block diagram according to an embodiment.

FIG. 2 illustrates an example system block diagram for a network connector.

FIG. 3A illustrates an example first operating environment.

FIG. 3B illustrates an example second operating environment.

FIG. 4 illustrates an embodiment of a signaling diagram according to an embodiment.

FIG. 5 illustrates a first logic flow diagram according to an embodiment.

FIG. 6 illustrates a second logic flow diagram according to an embodiment.

FIG. 7 illustrates an example of a storage medium.

FIG. 8 illustrates an example of a computer device.

### DETAILED DESCRIPTION

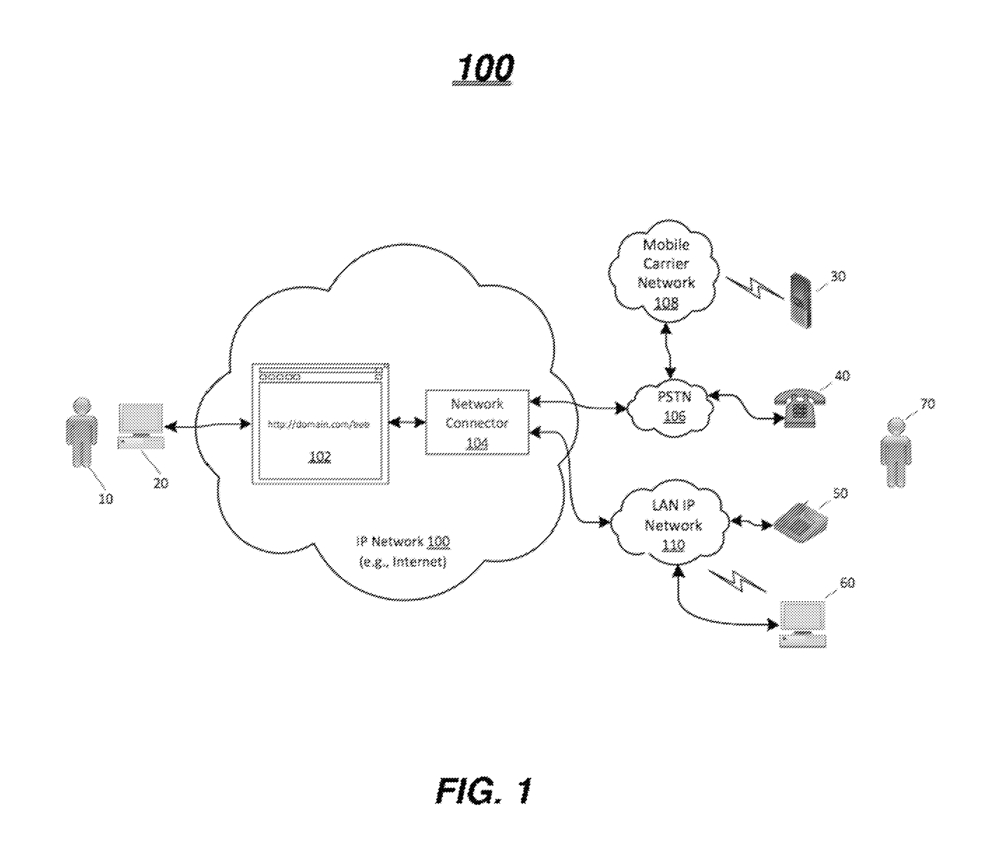

FIG. 1 illustrates a block diagram of a system and network infrastructure of an embodiment. As shown in FIG. 1, the network infrastructure makes use of a large scale Internet protocol (IP) network 100 such as, for instance, the Internet. Although the system/network embodiment shown in FIG. 1 has a limited number of elements in a certain topology or configuration, it may be appreciated that the system/network embodiment may include more or less elements in alternate configurations as desired for a given implementation. In various embodiments, the system/network embodiment may further comprise a first user's computing device 20 as shown in FIG. 1. The first user 10 may also be referred to as a caller. Thus, the terms “first user 10” and “caller 10” may be interchangeable. In some embodiments, the caller's computing device 20 may comprise a device capable of wired and/or wireless communication including, but not limited to, a computer, a laptop computer, a tablet computer, a smartphone, a personal digital assistant (PDA), or the like. The caller's computing device 20 is communicable with IP network 100 via one or more mechanisms including, but not limited to, a wired or wireless connection to an IP access point (not shown) and an Internet Service Provider (ISP), a wireless cellular IP data connection to a cellular basestation, or the like. Moreover, the caller's computing device 20 may execute a software application known as a web browser capable of navigating the Internet and displaying/executing individual webpages. The webpages are logically identified according to a universal resource indicator (URI) sometimes referred to as a universal resource locator (URL). In this example, the caller 10 may navigate his/her computing device 20 via a web browser, for instance, to a particular webpage identified by that webpage's URI. The embodiments are not limited in this respect.

In another embodiment, the caller's computing device 20 may not include a display component and may only include a voice recognition unit receiving input from a microphone as an input mechanism. The caller's computing device 20 may further include a speaker and/or a Bluetooth like RF coupling to a secondary audio input/output device. The caller may speak a URI and a command such as “Call Bob” to initiate a communication session with the person associated with the URI. The exact order and/or structure of the URI and command are subject to specific design implementations. The audio may be carried across a voice connection such as, but not limited to, a cellular connection, a Voice-over LTE (VoLTE) cellular data connection, or other telephony connection coupled with or routable to an IP based server that may parse and re-direct the command to the server associated with the URI for processing.

In the example of FIG. 1, the specific URI is “http://domain.co/bob” and the webpage 102 is loaded onto the caller's computing device 20 via a download from the IP network 100 (Internet) over the caller's computing device's Internet connection. The webpage 102 may include executable code that may be invoked by the caller via his/her computing device 20. The executable code may include code specifically intended to establish and maintain a bi-directional communication session with a second user 70. The second user 70 may also be referred to as the callee 70. Thus, the terms “second user 70” and “callee 70” may be interchangeable. To establish a bi-directional communication session with callee 70, the webpage 102 may be communicable with a network connector component 104. The network connector component 104 may manage one or more communication interfaces each capable of a communication session comprised of bi-directional video, voice, text, messaging or any combination thereof. The collection of communication interfaces may cover a variety of communication protocols including, but not limited to, Voice-over IP (VoIP) via session initiation protocol (SIP), various video codecs, etc. Moreover, the network connector component 104 may operate in conjunction with other network interface devices/servers to allow for communication paths that span other IP networks 110 and non-IP networks including, but not limited to, cellular telephony networks 108 and the public switched telephone network (PSTN) 106 before ultimately terminating with a telephony or communication device associated with the callee 70. Such callee 70 devices may include, but are not limited to, mobile devices 30 (e.g., a mobile phone) a plain old telephone service (POTS) phone 40, a VoIP phone 50, and a network accessible computing device 60. As with the computing device 20, the computing device 60 may comprise a device capable of wired and/or wireless communication including, but not limited to, a computer, a laptop computer, a tablet computer, a smartphone, a personal digital assistant (PDA), or the like capable of handling data including text, video, voice, messaging or any combination thereof.

In operation, caller 10 may wish to contact callee 70. Rather than using a telephone and trying to figure out which device callee 70 is currently near and its associated telephone number, caller 10 uses his/her computing device 20 to browse to the webpage 102 identified by the callee's URI. Once the web-page 102 loads onto the caller's computing device 20, caller 10 may activate an executable portion of the web page 102 to initiate a ‘call’ to callee 70. Activation may be a graphical user interface (GUI) function specific to the device or soft-client being used. One of ordinary skill in the art may readily ascertain options for implementing such GUIs. The webpage 102 can send and receive data streams including voice, video, messaging, or any combination thereof associated with a communication session by virtue of the Internet connection with the caller's computing device 20. The webpage's 102 executable code may determine a status of callee 70 such as, for instance, whether they have currently registered one or more specific telephony or computer devices on which they may be reached. If there is a preference, the webpage's 102 executable code may instruct the network connector component 104 to “ring” a particular device 30, 40, 50, 60 of callee 70. If there is no preference, the webpage's 102 executable code may instruct the network connector component 104 to “ring” all known devices 30, 40, 50, 60 of callee 70. The callee 70 may then choose to answer one of the devices 30, 40, 50, 60 to establish a bi-directional communication session with the caller 10 via the webpage 102.

In the manner described above and as described in more detail below, a caller can make a call to a callee using only a web browser and without having to know the telephone number of the callee. The caller need only know a URI associated with the callee. Often the URI will be descriptive or intuitive to the name of the callee making it easy to remember. For example, the URI may comprise some form of a “domain name/username” like that shown in FIG. 1 (http://domain.co/bob).

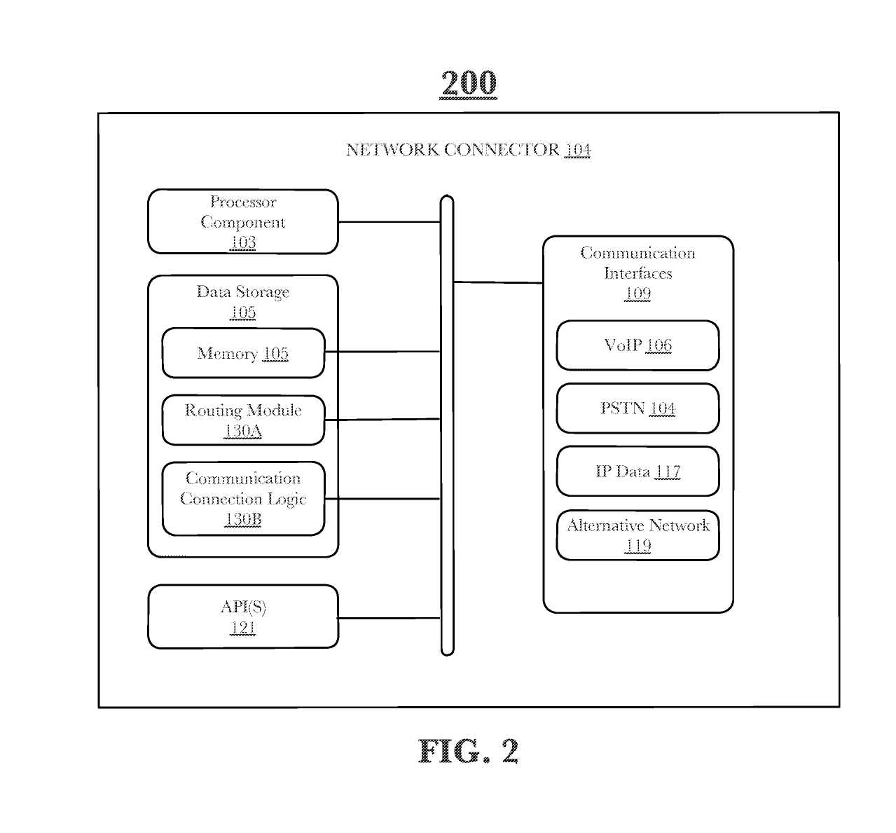

FIG. 2 is a block diagram illustrating some of the functions of the network connector 104 according to one or more embodiments described herein. The network connector 104 may comprise, for example, a server computer or any other system having computing capability. The schematic block diagram shows that the network connector 104 may include at least one processor component 103 (“processor 103” hereinafter), at least one communication interface 109 (e.g., a network interface card or the like), and a data storage component 105, each of which is coupled to a local interface 113. The local interface 113 may comprise, for example, a data bus with an accompanying address/control bus or other bus structure as can be appreciated. Stored in the data storage component 105 are a memory 107 and multiple components 130a-130b (e.g., software applications) that are executable by the processor 103 and that provide at least some of the functionality of the network connector 104.

Alternatively, while not shown in FIG. 2, a plurality of network connectors 104 may be employed and may be arranged, for example, in one or more server banks or computer banks or other arrangements. For example, a plurality of network connectors 104 together may comprise a cloud computing resource, a grid computing resource, and/or any other aggregated or distributed computing arrangement. Such network connectors 104 may be located in a single installation or may be distributed among different geographical locations. For purposes of convenience, the network connector 104 is illustrated in FIGS. 1 and 2 and referred to herein in the singular. Even though the network connector 104 is referred to in the singular, it is understood that a plurality of network connectors 104 may be employed in various arrangements as described above.

The communication interface(s) 109 may include a voice-over-IP (VoIP) interface 106 adapted to exchange IP based telephony signaling (e.g., SIP) and/or media data with other IP network devices using a VoIP protocol. Another communication interface 109 may be a PSTN interface 104 adapted to convert incoming PSTN audio data to VoIP audio data and convert outgoing VoIP audio data to PSTN audio data. Still another communication interface 109 may be an IP data interface 117 adapted to exchange IP data with other IP network devices. This may include IP data exchanged with a mobile wireless handset over an intermediate mobile carrier network. In addition to voice, it may also include the ability to exchange video, text, and messaging data or any combination thereof depending on the types and capabilities of the communication endpoints. Yet another communication network interface 109 may be directed toward an alternative network 115 adapted to exchange data with a wireless handset or a hybrid mobile device. Examples of alternative network(s) may include, but are not limited to, WiMax and whitespace. A whitespace network may be characterized as one that utilizes frequency spectrum that is overlapping with that of broadcast television frequency spectrum.

The network connector 104 may further include several inter-operable software modules operable with application programming interfaces (APIs) 121 and communication interfaces 109 and configured to intelligently establish and/or manage a communication session. These software modules may include a routing module 130a and communication connection logic 130b. The aforementioned software modules have functional names for convenience and ease of reference. These functional names should not be construed as limiting to the various software modules individually or the network connector 104 as a whole. There may be functions performed by one or more of the software modules in conjunction with the APIs 121 and network communication interfaces 109 that achieve a stated purpose or goal.

The routing module 130a may be configured to physically or logically connect communication links. The communication connection logic 130b may be configured to, among other things, establish a connection via a web browser or other URI enabled soft-client of a first endpoint 20 to one of a number of second communication devices or endpoints 30, 40, 50, 60 with the assistance of the routing module 130a. An endpoint may comprise a communication device such as a mobile phone, a POTS phone, and/or a VoIP phone. An endpoint may also comprise a soft client (e.g., software implementation on computer hardware) reachable via, for example, an IP address associated with a web site (URI) or a hosted software program having network access. The hosted software program may be resident on any number of computer devices that have IP network connectivity including, but not limited to, smartphones, desktop and laptop computers, tablet computers, personal digital assistants (PDAs), embedded automobile computer systems, etc. Communication sessions between a first endpoint or endpoint and a second endpoint may encompass voice, video, and/or messaging depending on the capabilities of the respective endpoints. A communication session establishment procedure supported by the communication connection logic 130b, including the use of a web browser at the first endpoint 20, is described in more detail below.

The routing module 130a may further include intelligence via a processor and memory that enables it to determine the connectivity preference of a user 70 with respect to that user's multiple endpoints 30-60. Additionally, the routing module 130a may be able to determine both presence and status (on-line or off-line) of the endpoints 30-60. The connectivity preference may be rules based in that the user may, via the intelligence supporting the URI, specify certain endpoints as active or inactive during certain times of day. For example, the user may specify that an endpoint associated with home is inactive during normal working hours. Conversely, an endpoint associated with work may be inactive during non-work hours while a mobile endpoint may be left active continuously. Other rules may specify how to route in incoming call or data stream based on the identity of the caller. The embodiments are not limited to these examples.

More specifically, the routing module 130a may cooperate with the APIs and network interfaces to physically or logically connect communication links to initially establish a communication session between communication devices and/or to perform a handoff of at least one communication link of a communication session from one network to another network. A communication session may be, for instance, between a first endpoint 20 and a second endpoint 30, 40, 50, 60. The routing module 130a may be configured to physically or logically establish communication links, join communication links, and sever communication links to a common or shared communication session based on commands or instructions received from the network connector 104.

The network connector 104 may execute various applications and/or other functionality for, among other things, setting-up, managing and tearing-down communication sessions between communication devices 20 and 30, 40, 50, 60. Also, various data may be stored in data storage 105 via memory 107 of the network connector 104. Data storage 105 illustrated in FIG. 2 may be representative of a plurality of data stores, as can be appreciated. The data stored in the data storage 105, for example, may be associated with the operation of the various applications and/or functional entities of the network connector 104.

The communication connection logic 130b may cooperate with the APIs and network interfaces to establish communication sessions between the first endpoint 20 and a second endpoint 30, 40, 50, 60. In various embodiments, communication connection logic 130b may be executed by the processor component 103 to receive a request to establish a bi-directional communication session (voice, video, text, messaging, and any combination thereof) between the first endpoint 20 and multiple endpoints 30, 40, 50, 60 via a uniform resource indicator (URI) accessed via a web browser or other soft-client of the first endpoint. The URI may comprise an executable portion of a web page accessed via the web browser in some embodiments. While the embodiments are not limited in this respect, the communication connection logic 130b may receive the request to establish the bi-directional communication session via, for example, a web real-time communication (WebRTC) application programming interface (API). Other examples of API functionality may include Adobe™ Flash™, and Microsoft™ CU-WebRTC. The embodiments are not limited to these examples.

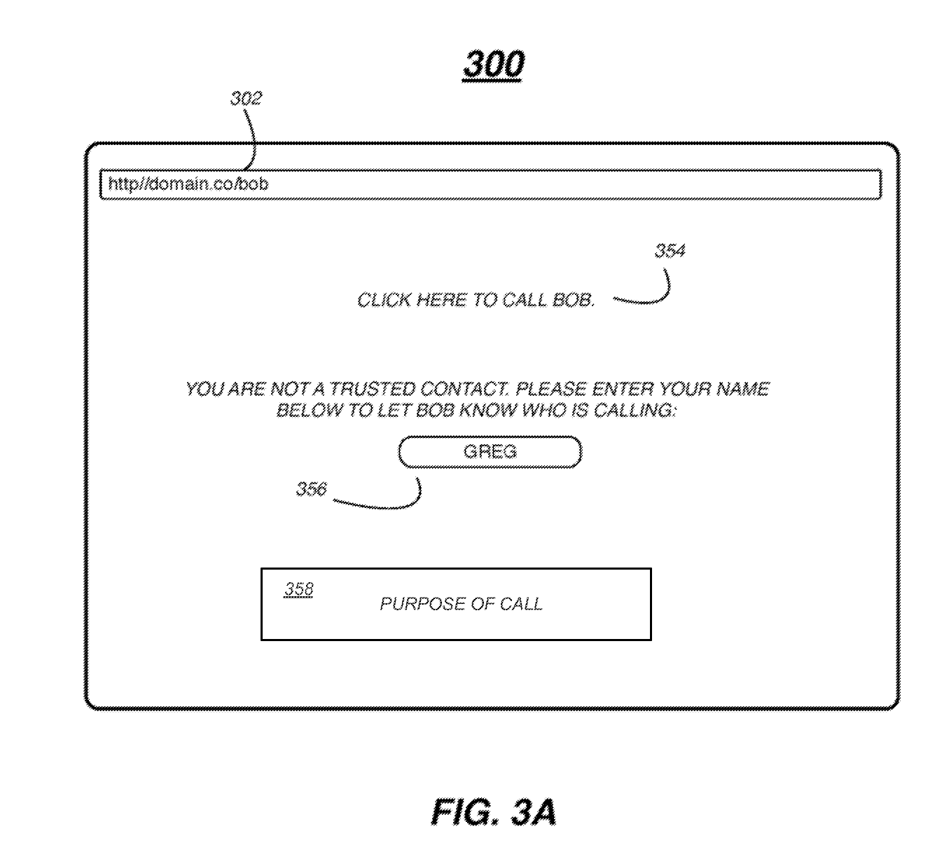

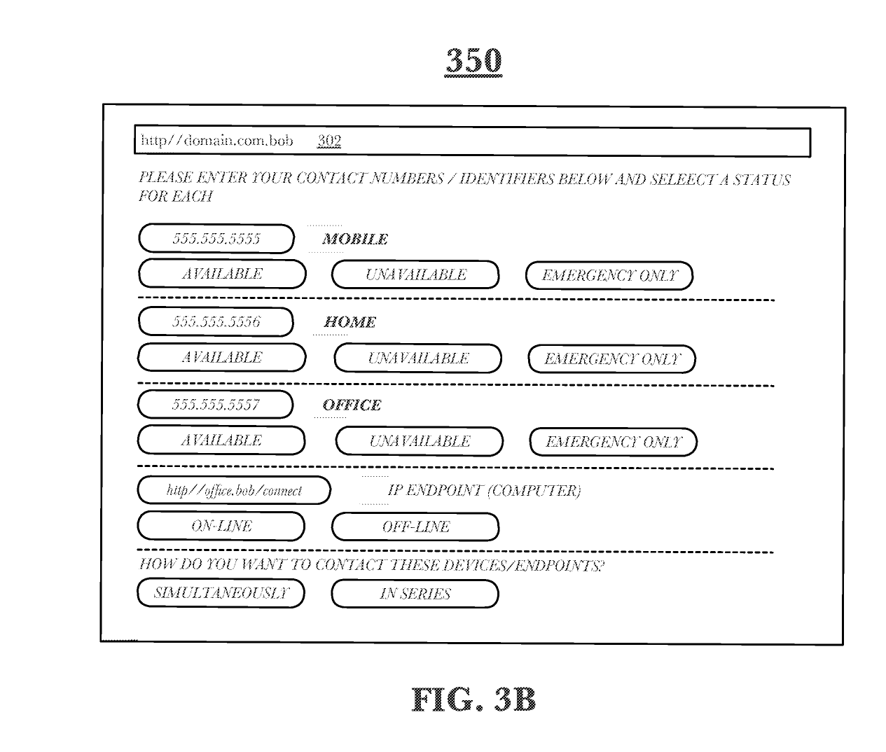

As shown in FIG. 3A, user 10 may activate a portion of the URI 354 displayed on web page (also referenced to herein as website) 300 which may be rendered by a web browser or other soft-client of computing device 20 to initiate a bi-directional communication session with user 70. The URI 354 may comprise a prompt for the user 10 to ‘CLICK HERE TO CALL BOB’ which may be automatically displayed when the user 10 visits the website located at http://domain.co/bob. In other embodiments, simply visiting the website located at http://domain.co/bob may be sufficient to initiate the bi-directional communication session request. As shown at 356, other information may also be displayed via the website 300. For example, the information 356 may comprise a request for additional identifying information if the user 10 is not a known or trusted contact of the user 70. For example, the caller may be prompted to input a name, telephone number, or other identifier in box 356 before the URI will attempt to establish a communication session with Bob. The caller provided response in box 356 may be authenticated against a user's contact database or other publicly available database. In addition, callers that cannot be authenticated may be asked to provide additional information in box 358 such as, for instance, a purpose for the communication session. Other embodiments are described and claimed.

In some embodiments, the communication connection logic 130b may identify the multiple endpoints based on or associated with the URI. For example, user 70 may have previously registered with the service/network connector 104 that hosts the web browser based calling and the URI 302 may be associated with a known set of contact numbers and/or endpoint identifiers associated with the user 70. In some embodiments, this registration may include or comprise selecting a domain or subdomain 302. The domain or subdomain 302 may be descriptive of the user in some embodiments. For example, the domain http://domain.co/bob may be associated with a user 70 named Bob. Once registered, the user 70 may be prompted, as shown in FIG. 3B, to enter one or more contact numbers 304 associated with one or more devices 30, 40, 50, 60.

In the example shown in FIG. 3B, the contact numbers 304 may be associated with mobile, home and office numbers/devices/endpoints under the control of or at which the user 70 can be reached. One or more of these numbers/devices/endpoints may be associated with a different communication protocol and/or different communication network in some embodiments. While the embodiments are not limited in this respect, the website 350 may additionally allow for the user 70 to enter status information for each number/device/endpoint (e.g. available, unavailable, emergency only, etc.) to indicate if they are currently able to be reached at that destination and may also allow the user 70 to select how (e.g. at 306) the entered contact information 304 should be contacted (e.g. simultaneously or in series). One skilled in the art will understand that any number of setup, registration or maintenance features could be implemented for user 70 via website 350 and the embodiments are not limited to the examples described herein.

In various embodiments, the communication connection logic 130b may be operative to send a connection request to one or more of the multiple endpoints. For example, in response to the connection request received from a computing device 20 or other first endpoint, communication connection logic 130b of network connector 104 may send a connection request to one or more of second endpoints 30, 40, 50, 60. In some embodiments, the connection request may be sent to each of second endpoints 30, 40, 50, 60. In other embodiments, communication connection logic 130b may receive status information for the multiple endpoints 30, 40, 50, 60 and may send the connection request to one or more of the second endpoints indicated as available via the status information which may have been previously entered as described above or which may be indicated on a device by device or endpoint by endpoint basis by the user 70. The embodiments are not limited in this respect.

In some embodiments, the communication connection logic 130b may send the connection request to two or more second endpoints 30, 40, 50, 60 using two or more disparate communication protocols for two or more disparate networks. For example, as shown in FIG. 1, the two or more disparate communication protocols and disparate networks may comprise at least one of a mobile carrier network, a public switched telephone network (PSTN) or an Internet Protocol (IP) based packet data network.

In addition to the information described above with reference to FIG. 3B, the user 70 may also be prompted to enter, via any of second endpoints 30, 40, 50, 60, trusted contact information for users that are familiar to the user 70. This may allow the user 70 to control who can contact them directly via their URI. For example, the user 70 may wish to upload or otherwise make available their address book of trusted contact information to the website. Once known to the communication connection logic 130b, communication connection logic 130b may be operative to utilize the trusted contact information to make decisions regarding establishing the bi-directional communication session. For example, communication connection logic 130b may determine if the first endpoint comprises a trusted contact based on the trusted contact information and automatically establish the bi-directional communication session if the first endpoint comprises a trusted contact. If the first endpoint does not comprise a trusted contact, communication connection logic 130b may request additional information from the first endpoint as shown, for example, at 356 in FIG. 3A. In some embodiments, the additional information may comprise identification information (e.g. a name, alias, phone number, etc.) for a user of the first endpoint. Other embodiments are described and claimed.

The connection request may prompt the second endpoints 30, 40, 50, 60 to indicate to user 70 that someone (e.g. user 10) is trying to contact them. This prompt may comprise an audio prompt, a tactile prompt and/or a visual prompt. The audio prompt may comprise playing an audio sound or ring. The tactile prompt may comprise activating a vibration mechanism of the second endpoints 30, 40, 50, 60. The visual prompt may comprise the generation of one or more graphical user interface (GUI) elements to notify the user 70 of the connection request. Each of the prompts may allow for the user 70 to accept, decline or defer the connection request. In other embodiments, the user 70 may not be available or may not notice the prompts and the connection request will be ignored completely.

In response to the user 70 acting upon the prompt and/or ignoring the prompt associated with the connection request, one or more of second endpoints 30, 40, 50, 60 may send a response to the network connector 104. For example, communication connection logic 130b may receive a connection acceptance response or a connection denial response from one of the multiple endpoints 30, 40, 50, 60. Based on the received response, the communication connection logic 130b may initiate the establishment of the bi-directional communication session between the first endpoint 20 and the one of the multiple endpoints 30, 40, 50, 60. The embodiments are not limited in this respect. Other embodiments are described and claimed.

In various embodiments, the connection requests may involve routing the request to a device 60 having IP connectivity and capable of sending and receiving rich media streams via a third party service. In such cases, the endpoint device 60 is a combination of hardware providing physical IP connectivity and software providing the logical connectivity for signaling and the actual IP packet media stream. Examples of third party rich media communication service providers may include, but are not limited to Microsoft™ Skype™, Google™ Hangouts™, Apple™ Facetime™, and the like. Thus, the user may register one or more third party user identifiers as ‘soft’ endpoints associated with an IP data physical endpoint 60.

In various embodiments, any of the foregoing functionality may be enabled by communication connection logic 130b. For example, at least one non-transitory machine-readable medium may comprise a set of instructions that in response to being executed on a computing device cause the computing device to perform any of the functionality, methods and/or processes described herein. In some embodiments, an apparatus may comprise a processor component and communication connection logic 130b to be executed by the processor component to perform any of the functionality, methods and/or processes described herein. In other embodiments, a system may comprise a processor component, memory coupled to the processor component and communication connection logic 130b to be executed by the processor component to perform any of the functionality, methods and/or processes described herein. The embodiments are not limited in this respect.

Included herein is a set of flow charts and message diagrams representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

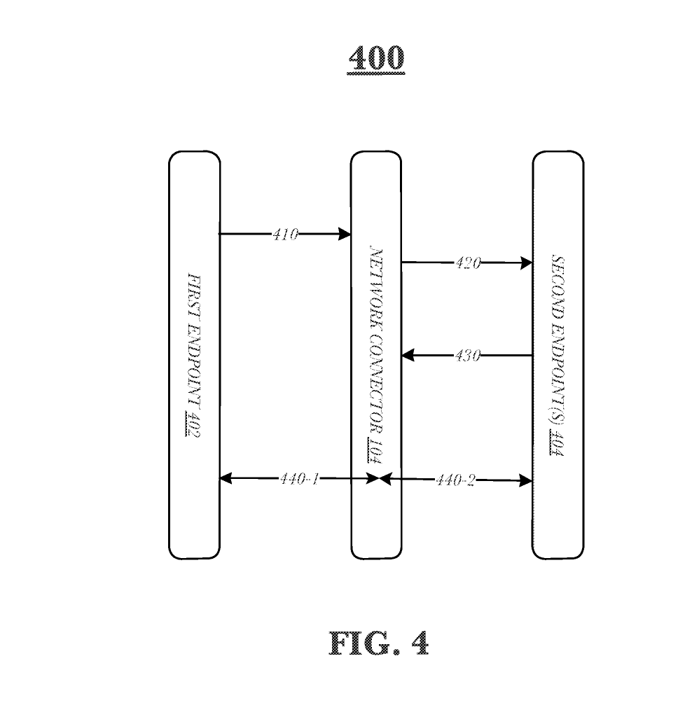

FIG. 4 illustrates an example of a signaling diagram 400. For example, signaling diagram 400 may represent one embodiment of the signals exchanged between a first endpoint 402, a network connector 104 and multiple endpoints 404 to establish a communication session via web browser accessed via first endpoint 402. In some embodiments, the first endpoint 404 may be the same or similar to communication device 20 of FIG. 1 and the second endpoint(s) 404 may be the same or similar to communication devices 30, 40, 50, 60 of FIG. 1. The embodiments are not limited in this respect. Moreover, the embodiments are not limited to the number, type or order of the steps set forth in the signaling diagram 400.

At 410, a request to establish a bi-directional communication session between the first endpoint 402 and multiple endpoints 404 may be sent from the first endpoint 402 to the network connector 104. In some embodiments, the request may be initiated from a web page associated with a uniform resource indicator (URI) accessed via a web browser or other soft-client capable of accessing and rendering a URI of the first endpoint 404. At 420, a communication session connection request may be sent from the network connector 104 to one or more of the multiple endpoints 404. For example, the network connector 104 may send a communication session connection request to one or more of devices 30, 40, 50, 60 based on preference and/or availability information entered by user 70.

In various embodiments, a communication session connection response may be sent from the second endpoint(s) 404 to the network connector 104. This response may include an acceptance of the communication session connection request, a denial of the communication session connection request or an indication that no response to the request was received. If the response received at 430 comprises an acceptance, a bi-directional communication session between the first endpoint 402 and one of the second endpoint(s) 404 may be established at 440-1, 440-2 whereby the network connector 104 mediates or otherwise controls one or more media channel(s) for the bi-directional communication session. The embodiments are not limited in this respect.

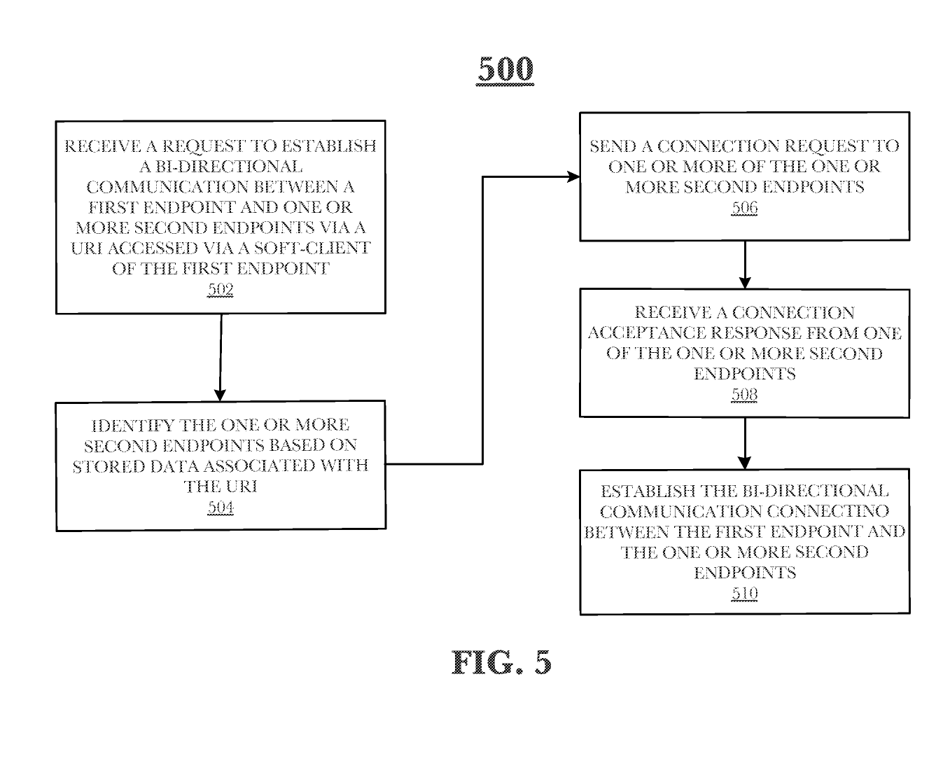

FIG. 5 illustrates an example of a first logic flow 500. Logic flow 500 may be representative of some or all of the operations executed by one or more logic, features, or devices described herein, such as any devices or systems described above with references to FIGS. 1 and 2 for example. In the illustrated example shown in FIG. 5, logic flow 500 may comprise one or more steps involved in establishing a communication session between two endpoints based on communication session connection request received via a rendering of a URI that is associated with the callee as described elsewhere herein. The embodiments, however, are not limited to the number, type, order or arrangement of steps shown in FIG. 5.

In various embodiments, the logic flow at 502 includes receiving a communication session connection request to establish a bi-directional communication session between a first endpoint and multiple endpoints via intelligence associated with a uniform resource indicator (URI) accessed via a web browser or other soft-client of the first endpoint. For example, user 10 may visit a web page by navigating to a specific URI associated with the intended recipient (e.g., http://domain.co/bob) using web browser 102 of endpoint 20 or a special purpose application resident on endpoint 20 and, based on visiting this page or interacting with this page may indicate a desire to establish a communication session with user 70. The user 10 may not care how they connect to the user 70 and the user 70 may have previously indicated that they may be contacted using one or more different telephone numbers or other endpoint identifiers, via one or more different networks associated with one or more different endpoints 30, 40, 50, 60.

At 504, the logic flow may include identifying the multiple endpoints based on stored data associated with the URI. For example, the network connector 104 may store information previously entered by user 70 that associates the URI with user endpoints 30, 40, 50, 60. Additionally, the user 70 may also update the web page associated with the URI to indicate status and/or presence information associated with user 70 and/or any of endpoints 30, 40, 50, 60. The status and/or presence information may be dynamically updated by user 70 or may be rules-based according to time of day, location information, or calendar information. The embodiments are not limited in this respect.

In some embodiments, the logic flow at 506 may include sending a communication session connection request to one or more of the multiple endpoints. For example, network connector 104 may send concurrent communication session connection requests to each of user 70 devices 30, 40, 50, 60, to only devices currently indicated as available by user 70, to each or any number of devices 30, 40, 50, 60 in series based on a priority and/or calling order established by user 70, etc. At 508 the logic flow may include receiving a communication session connection acceptance response from one of the multiple endpoints. For example, user 70 may wish to accept the communication session connection request from network connector 104 as initiated by user 10 over user 70's web page using endpoint 30 and may indicate as such using endpoint 30. This action by user 70 may result in the communication session connection acceptance response being generated and sent from endpoint 30 to network connector 104. In other embodiments, the user may wish to deny the communication session connection request, ignore the communication session connection request, or may not be aware of the communication session connection request. In these embodiments, the response from one or more of endpoints 30, 40, 50, 60 or lack of response from any of endpoints 30, 40, 50, 60 may indicate that a communication session is not desired.

In some embodiments, the logic flow at 510 may include establishing a bi-directional communication session between the first endpoint and one of the multiple second endpoints. For example, if the user 70 accepts the communication session connection request using endpoint 30, network connector 104 may set up and mediate a bi-directional communication session (e.g., a media channel) between user 10 and user 70 using first endpoint 20 and one of second endpoints 30, 40, 50, or 60 respectively. The media channel may encompass multiple media protocols depending on the type of endpoints 20, 30, 40, 50, or 60 involved. The media channel for user 10's endpoint 20 (e.g., a computer) may be a webRTC media link since it represents a web browser connection with the web page of user 70 (e.g., http://domain.co/bob). The media channel for user 70's endpoint 30, 40, 50, or 60 may initially be a packet based (e.g., WebRTC or VoIP) connection and may be converted to a different media link if user 70's targeted endpoint is not packet based such as, for instance, a POTS phone endpoint 40 or a mobile phone endpoint 30. For a POTS phone endpoint 40, the packet based link will be converted to a PSTN link at the intersection of the IP network and the PSTN 106. Similarly, the packet based link may first be converted to a PSTN link at the intersection of the IP network 100 and the PSTN 106 and then be converted to a mobile (e.g., cellular) link at the intersection of PSTN 106 and the mobile network 108. For a VoIP phone endpoint 50, the packet based link may be formatted as a VoIP link while for a computer device endpoint 60, the packet based link may be formatted as a WebRTC link or other rich media type link. The embodiments are not limited in this respect.

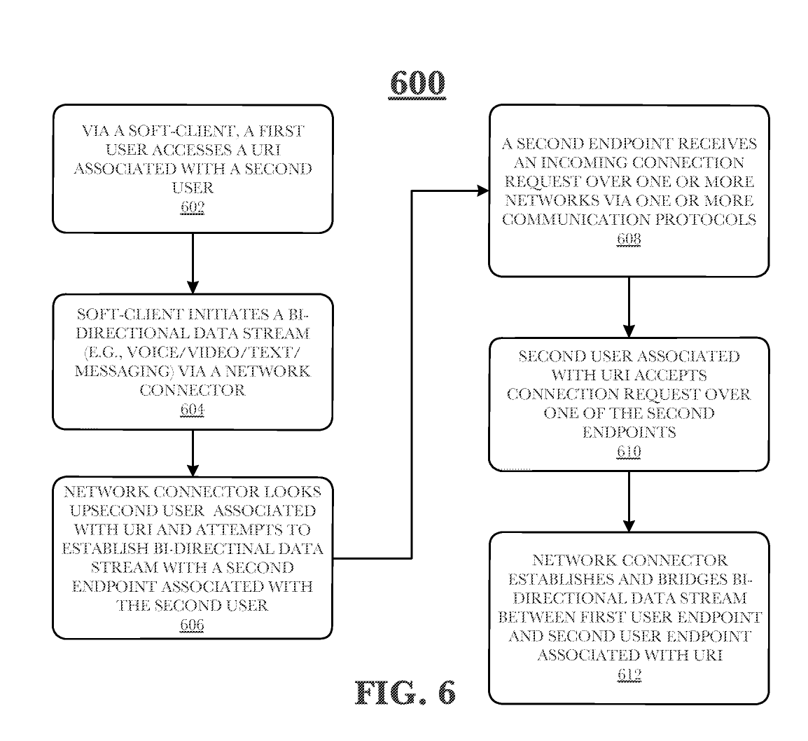

FIG. 6 illustrates an example of a second logic flow 600. Logic flow 600 may be representative of some or all of the operations executed by one or more logic, features, or devices described herein, such as any devices, equipment or systems described above with references to FIGS. 1 and 2 for example. In the illustrated example shown in FIG. 6, logic flow 600 may comprise one or more steps involved in establishing a communication session between two endpoints based on a request received via a website identifiable by a personalized URI and controlled by the callee as described elsewhere herein. The embodiments, however, are not limited to the number, type, order or arrangement of steps shown in FIG. 6.

As shown in FIG. 6, via a web browser or other soft-client on an endpoint computing device 20 a first user (e.g., caller 10) accesses a URI associated with a second user (e.g., callee 70) at block 602. As described above, the endpoint computing device 20 may take several forms and is communicable with a server within IP network 100 so as to be able to download and render a web page 102 or other content associated with the URI via a web browser or other soft-client such as a specific purpose application (e.g., app). Via first user interaction with the soft-client rendering the URI, the soft-client initiates a bi-directional communication session with the second user via a network connector component 104 at block 604. The network connector component 104 may look up the second user associated with the URI and attempt to establish bi-directional communication session with the second user associated with the URI at block 606. The network connector component 104 may be operative to contact one or more of the second user's endpoints 30, 40, 50, 60 using one or more communication protocols over one or more disparate networks.

The second user associated with the URI may receive an incoming communication session connection request on one or more second endpoints 30, 40, 50, 60 that are communicable over one or more networks via one or more communication protocols at block 608. The second user associated with the URI may accept one or more of the communication session connection requests over one or more of the endpoints 30, 40, 50, 60 at block 610. The network connector component 104 may then establish a bi-directional communication session between the first user and their endpoint computing device 20 and the second user associated with URI and one or more of their endpoints 30, 40 50, 60 at block 612. The embodiments are not limited to this example.

In another embodiment, a first user may use a first device (endpoint) to interface with the URI and request the web page 102 or other content rendering of the URI to establish a connection to the second user associated with the URI on one or more second endpoints associated with the second user while also instructing the web page 102 or other content rendering of the URI to contact the first user back over a different endpoint. For example, the first user may use a laptop computer to interact with the web page 102 or other content rendering of the URI but wish to establish a phone call with the second user associated with the URI on the first user's mobile phone and not the laptop computer endpoint used to interact with the web page 102 or other content rendering of the URI. Thus, the first user may request/instruct the web page 102 or other content rendering of the URI to establish a connection between the first user and the second user associated with the URI using a first user's device/endpoint of the first user's choosing.

In still another embodiment, the first user may also request/instruct the web page 102 or other content rendering of the URI to bridge one or more additional endpoints not necessarily associated with either the first user or the second user associated with the URI. The first user could supply the web page 102 or other content rendering of the URI with the requisite endpoint contact information (e.g., telephone number, SIP address, etc.) and have the web page 102 or other content rendering of the URI via the network connector 104 establish the communication link requested and join it to the communication session.

In yet another embodiment, a visitor to the web page 102 or other content rendering associated with the URI may set up a communication session between the user associated with the URI and a third party. In this scenario the first user would supply the web page 102 or other content rendering of the URI with the requisite endpoint contact information (e.g., telephone number, SIP address, etc.) of the third and have the web page 102 or other content rendering of the URI via the network connector 104 establish the communication link requested and join it to the communication session between the third party and the second user associated with the URI.

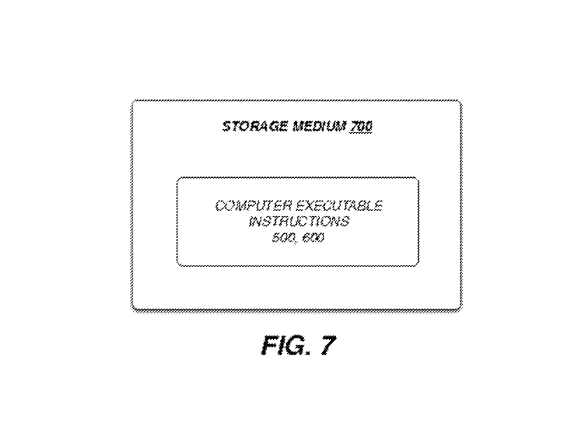

FIG. 7 illustrates an embodiment of a first storage medium. As shown in FIG. 7, the first storage medium includes a storage medium 700. Storage medium 700 may comprise an article of manufacture. In some examples, storage medium 700 may include any non-transitory computer readable medium or machine-readable medium, such as an optical, magnetic or semiconductor storage. Storage medium 700 may store various types of computer executable instructions, such as instructions to implement one or more of logic flows 500 and/or 600. Examples of a computer readable or machine readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, assembly code, machine code, and the like. The examples are not limited in this context.

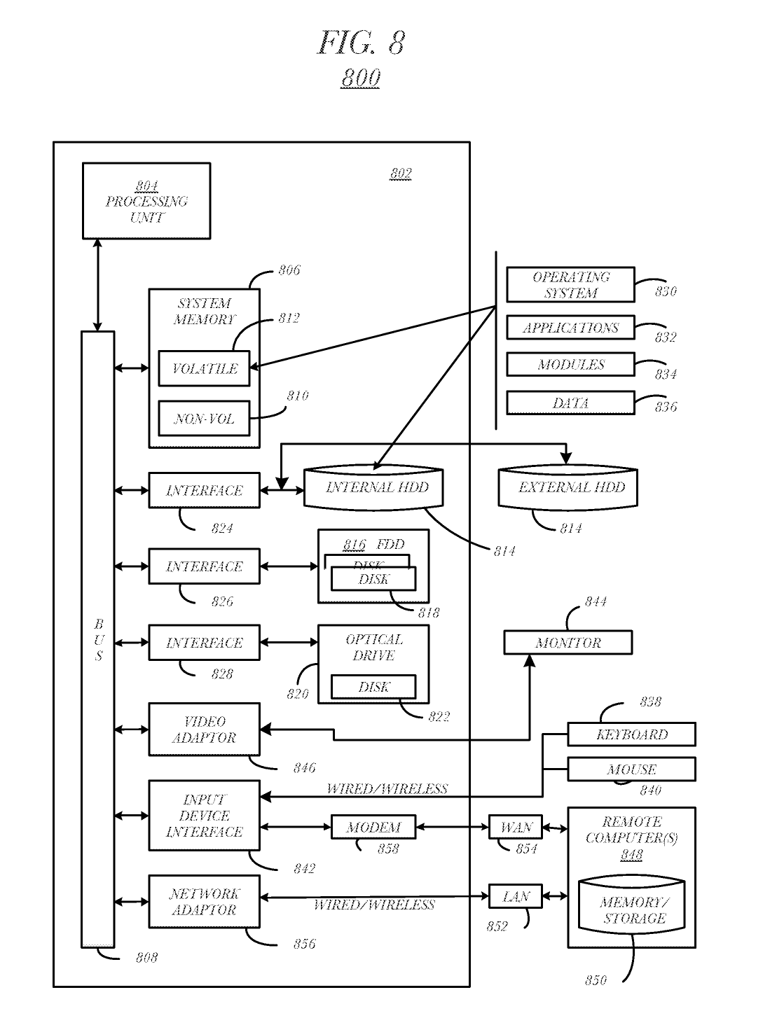

FIG. 8 illustrates an embodiment of an exemplary computing architecture 800 suitable for implementing various embodiments as previously described. In one embodiment, the computing architecture 800 may comprise or be implemented as part of an electronic device. The embodiments are not limited in this context.

As used in this application, the terms “system” and “component” are intended to refer to a computer-related entity, either hardware, a combination of hardware and software, software, or software in execution, examples of which are provided by the exemplary computing architecture 800. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 800 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 800.

As shown in FIG. 8, the computing architecture 800 comprises a processing unit 804, a system memory 806 and a system bus 808. The processing unit 804 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 804.

The system bus 808 provides an interface for system components including, but not limited to, the system memory 806 to the processing unit 804. The system bus 808 can be any of several types of bus structure that may further interconnect to a memory bus (with or without a memory controller), a peripheral bus, and a local bus using any of a variety of commercially available bus architectures. Interface adapters may connect to the system bus 808 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 800 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 806 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 8, the system memory 806 can include non-volatile memory 810 and/or volatile memory 812. A basic input/output system (BIOS) can be stored in the non-volatile memory 810.

The computer 802 may include various types of computer-readable storage media in the form of one or more lower speed memory units, including an internal (or external) hard disk drive (HDD) 814, a magnetic floppy disk drive (FDD) 816 to read from or write to a removable magnetic disk 818, and an optical disk drive 820 to read from or write to a removable optical disk 822 (e.g., a CD-ROM or DVD). The HDD 814, FDD 816 and optical disk drive 820 can be connected to the system bus 808 by a HDD interface 824, an FDD interface 826 and an optical drive interface 828, respectively. The HDD interface 824 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 810, 812, including an operating system 830, one or more application programs 832, other program modules 834, and program data 836. In one embodiment, the one or more application programs 832, other program modules 834, and program data 836 can include, for example, the various applications and/or components of the system 100.

A user can enter commands and information into the computer 802 through one or more wire/wireless input devices, for example, a keyboard 838 and a pointing device, such as a mouse 840. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 804 through an input device interface 842 that is coupled to the system bus 808, but can be connected by other interfaces such as a parallel port, IEEE 1394 serial port, a game port, a USB port, an IR interface, and so forth.

A monitor 844 or other type of display device is also connected to the system bus 808 via an interface, such as a video adaptor 846. The monitor 844 may be internal or external to the computer 802. In addition to the monitor 844, a computer typically includes other peripheral output devices, such as speakers, printers, and so forth.

The computer 802 may operate in a networked environment using logical connections via wire and/or wireless communications to one or more remote computers, such as a remote computer 848. The remote computer 848 can be a workstation, a server computer, a router, a personal computer, portable computer, microprocessor-based entertainment appliance, a peer device or other common network node, and typically includes many or all of the elements described relative to the computer 802, although, for purposes of brevity, only a memory/storage device 850 is illustrated. The logical connections depicted include wire/wireless connectivity to a local area network (LAN) 852 and/or larger networks, for example, a wide area network (WAN) 854. Such LAN and WAN networking environments are commonplace in offices and companies, and facilitate enterprise-wide computer networks, such as intranets, all of which may connect to a global communications network, for example, the Internet.

When used in a LAN networking environment, the computer 802 is connected to the LAN 852 through a wire and/or wireless communication network interface or adaptor 856. The adaptor 856 can facilitate wire and/or wireless communications to the LAN 852, which may also include a wireless access point disposed thereon for communicating with the wireless functionality of the adaptor 856.

When used in a WAN networking environment, the computer 802 can include a modem 858, or is connected to a communications server on the WAN 854, or has other means for establishing communications over the WAN 854, such as by way of the Internet. The modem 858, which can be internal or external and a wire and/or wireless device, connects to the system bus 808 via the input device interface 842. In a networked environment, program modules depicted relative to the computer 802, or portions thereof, can be stored in the remote memory/storage device 850. It will be appreciated that the network connections shown are exemplary and other means of establishing a communications link between the computers can be used.

The computer 802 is operable to communicate with wire and wireless devices or entities using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled”, “connected”, or “capable of being coupled” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

In the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What is claimed is:

1. At least one non-transitory machine-readable medium comprising a set of instructions that in response to being executed on a computing device cause the computing device to:
receive a request to establish a bi-directional communication session between a first user and a second user over an IP network or the IP network and at least one additional network, wherein
the communication session is between a first endpoint and at least one of multiple second endpoints associated with the second user, and
the communication session is initiated by the first endpoint through first user interaction with a soft-client accessing a uniform resource indicator (URI) associated with the second user.

2. The at least one non-transitory machine-readable medium of claim 1, comprising instructions that in response to being executed on the computing device cause the computing device to:
send a communication session connection request to one of the multiple second endpoints based on user interaction with the soft-client via the first endpoint;
receive a communication session connection acceptance response from the second endpoint to which the communication session connection request was sent;
establish a first communication link with the first endpoint and a second communication link with the second endpoint; and
join the first communication link and the second communication link to establish the communication session between the first endpoint and the second endpoint.

3. The at least one non-transitory machine-readable medium of claim 1, the first endpoint comprising an IP address to which the soft-client can access and render.

4. The at least one non-transitory machine-readable medium of claim 3, the soft-client comprising a web browser.

5. The at least one non-transitory machine-readable medium of claim 1, the soft-client comprising a voice recognition component.

6. The at least one non-transitory machine-readable medium of claim 1, the second endpoints comprising one or more of a computer device, a smartphone, a tablet computer, a VoIP phone, a POTS phone, a SIP address, a third party service provider identifier, and an IP address.

7. The at least one non-transitory machine-readable medium of claim 1, comprising instructions that in response to being executed on the computing device cause the computing device to send the communication session connection request to two or more second endpoints.

8. The at least one non-transitory machine-readable medium of claim 1, the at least one additional network comprising at least one of a mobile carrier network, a public switched telephone network (PSTN) or additional Internet Protocol (IP) based packet data networks.

9. The at least one non-transitory machine-readable medium of claim 1, comprising instructions that in response to being executed on the computing device cause the computing device to establish the first communication link with the first endpoint over a web real-time communication (WebRTC) application programming interface (API).

10. The at least one non-transitory machine-readable medium of claim 1, comprising instructions that in response to being executed on the computing device cause the computing device to:
receive status information for the multiple second endpoints; and
send the communication session connection request to multiple of the second endpoints indicated as available via the status information using identifiers, networks, and protocols associated with the second endpoints.

11. The at least one non-transitory machine-readable medium of claim 1, comprising instructions that in response to being executed on the computing device cause the computing device to:
determine if the first endpoint comprises a trusted contact based on trusted contact information stored by the computing device and associated with the URI;
automatically initiate establishment of the communication session if the first endpoint comprises a trusted contact; and
request additional information, via interaction with the soft-client, from the first endpoint if the first endpoint is not a trusted contact.

12. The at least one non-transitory machine-readable medium of claim 11, the additional information comprising identification information for a user of the first endpoint.

13. The at least one non-transitory machine-readable medium of claim 11, the additional information further comprising a reason for the communication session.

14. The at least one non-transitory machine-readable medium of claim 1, comprising instructions that in response to being executed on the computing device cause the computing device to:
accept contact information for an alternative first endpoint wherein establishing the first communication link is performed with respect to the alternative first endpoint.

15. The at least one non-transitory machine-readable medium of claim 14, the alternative first endpoint comprising one or more of a telephone number, a SIP address, and a third party service provider identifier.

16. An apparatus, comprising:
a processor component; and
communication connection logic to be executed by the processor component to:
receive a request to establish a bi-directional communication session between a first user and a second user over an IP network or the IP network and at least one additional network, wherein
the communication session is between a first endpoint and at least one of multiple second endpoints associated with the second user, and
the communication session is initiated by the first endpoint through first user interaction with a soft-client accessing a uniform resource indicator (URI) associated with the second user.

17. The apparatus of claim 16, the communication connection logic to be executed by the processor component to:
send a communication session connection request to one of the multiple second endpoints based on user interaction with the soft-client via the first endpoint;
receive a communication session connection acceptance response from the second endpoint to which the communication session connection request was sent;
establish a first communication link with the first endpoint and a second communication link with the second endpoint; and
join the first communication link and the second communication link to establish the communication session between the first endpoint and the second endpoint.

18. The apparatus of claim 17, the first endpoint comprising an IP address to which the soft-client can access and render.

19. The apparatus of claim 16, the soft-client comprising a web browser.

20. The apparatus of claim 16, the soft-client comprising a voice recognition component.

21. The apparatus of claim 16, the second endpoints comprising one or more of a computer device, a smartphone, a tablet computer, a VoIP phone, a POTS phone, a SIP address, a third party service provider identifier, and an IP address.

22. The apparatus of claim 16, the communication connection logic to be executed by the processor component to send the communication session connection request to two or more second endpoints.

23. The apparatus of claim 16, the at least one additional network comprising at least one of a mobile carrier network, a public switched telephone network (PSTN) or additional Internet Protocol (IP) based packet data networks.

24. The apparatus of claim 16, the communication connection logic to be executed by the processor component to establish the first communication link with the first endpoint over a web real-time communication (WebRTC) application programming interface (API).

25. The apparatus of claim 16, the communication connection logic to be executed by the processor component to:
receive status information for the multiple second endpoints; and
send the communication session connection request to multiple of the second endpoints indicated as available via the status information using identifiers, networks, and protocols associated with the second endpoints.

26. The apparatus of claim 16, the communication connection logic to be executed by the processor component to:
determine if the first endpoint comprises a trusted contact based on trusted contact information stored by the computing device and associated with the URI;
automatically initiate establishment of the communication session if the first endpoint comprises a trusted contact; and
request additional information, via interaction with the soft-client, from the first endpoint if the first endpoint is not a trusted contact.

27. The apparatus of claim 26, the additional information comprising identification information for a user of the first endpoint.

28. The apparatus of claim 26, the additional information further comprising a reason for the communication session.

29. The apparatus of claim 16, the communication connection logic to be executed by the processor component to:
accept contact information for an alternative first endpoint wherein establishing the first communication link is performed with respect to the alternative first endpoint.

30. The apparatus of claim 29, the alternative first endpoint comprising one or more of a computer device, a smartphone, a tablet computer, a VoIP phone, a POTS phone, a SIP address, and a third party service provider identifier.
